(19) United States
(12) Patent Application Publication
(10) Pub. No.: US 2003/0154590 A1
(43) Pub. Date: Aug. 21, 2003

(54) Circuit member processor

(76) Inventor: Masao Watanabe, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/258,180

(22) PCT Filed: Apr. 2, 2002
(86) PCT No.: PCT/JP02/03300

(30) Foreign Application Priority Data
Apr. 6, 2001 (JP) 2001-109157

(51) Int. Cl. H01S 4/00

(52) U.S. Cl. 29/592.1

(57) ABSTRACT

A multi-layer substrate 2 is reacted with supercritical water in a reaction chamber 14 whose cross section is in the form of an elongated hollow ellipse, and the reaction chamber 14 has a central part having a small curvature, exhibiting substantially a straight line, and end parts having a large curvature, so that the central part of the reaction chamber 14 is suitable for introducing flat materials such as multi-layer substrates 2 thereinto. Furthermore, the large curvature of the reaction chamber 14 at the ends thereof provides a wider inner surface, thereby enabling the reaction chamber 14 to be proof against a high pressure.

### TECHNICAL FIELD

The present invention relates to the technology of processing a circuit component such as a multi-layer substrate.

### BACKGROUND ART

At present, electronic instruments are indispensable to our ordinary life, and each of them includes electronic circuits. Moreover, such an electronic circuit is produced by mounting circuit parts on a multi-layer substrate. The multi-layer substrate is a complicated high-tech part having fine structures, wherein this part is produced in such a manner that individual substrates each made of metal, inorganic material and the like are superposed on each other in the form of a multi-layer, and the electric connection between the substrates is carried out via through holes provided therein. At present, the productive capacity of the multi-layer substrates in Japan has been estimated to be approximately 80 million yens.

The multi-layer substrate includes epoxy, polyimide, solder (SnPb) and further valuable metals, such as Cu, Ni, Au and the like. As a result, in the disposal of multi-layer substrates, there is a strong requirement that macro molecular materials, such as epoxy, polyimide and the like, as well as the valuable metals, such as Cu, Ni, Au and the like, can be recycled, and a great amount of solder can be collected without any environmental pollution.

In the disposal or process of such a multi-layer substrate, it is difficult to apply the decomposition process, since elements made respectively of metals, glass and macro molecular material are bound to each other in a very complicated manner within the substrate.

Accordingly, in the disposal or process of the multi-layer substrates, electronic parts are firstly removed from the multi-layer substrate at a temperature of 250° C. or so, and then the multi-layer substrate is ground to very fine pieces, which are eventually burned. In this case, the macro molecular materials are gasified by the combustion, but the metals and glass still remain even after the combustion. Hence, the metals can be recycled and the glass can be reclaimed.

When, however, such a multi-layer substrate is burned, harmful gas, such as dioxin or the like, always generates due to the burning of the macro molecular materials. In addition, a great effort is required for removing the electronic parts from the substrate. Such a problem can be encountered not only in the disposal of the multi-layer substrate, but also in the process of IC's (Integrated Circuits), so that this problem generally arises in the disposal of circuit components and electric parts.

From this viewpoint, a method for processing a multi-layer substrate with the aid of supercritical water has already been proposed in Japanese Unexamined Patent Publication No. 2000-107725 (the method and apparatus for processing components).

However, the reaction using the supercritical water is conducted at a high temperature of max. 650° C. under a high pressure of max. 30 MPa, so that the process apparatus must be designed to allow a stable operation of the reaction chamber under such severe conditions. Moreover, a prompt processing is required since the multi-layer substrates are manufactured at a high production rate.

Accordingly, it is the object of the present invention to provide a circuit component processing apparatus, which is suitable for processing circuit components such as multiplayer substrates or the like with the supercritical water.

### DISCLOSURE OF THE INVENTION

The invention described in claim 1 is a circuit component processing apparatus wherein circuit components are reacted with supercritical water, the apparatus including: a reaction means in which the circuit components are reacted with the supercritical water, wherein the reaction means is equipped with an elongated ellipse cylinder shaped reaction chamber having a hollow ellipse cross section, the reaction chamber having a small curvature at the center part, thereby exhibiting substantially straight line, and a large curvature at its ends.

In accordance with the circuit component processing apparatus having the above-mentioned structural arrangement, the central part of the reaction chamber is designed to be suitable for introducing circuit components, such as multi-layer substrates, each having a flat shape, into the chamber. Moreover, each end part of the reaction chamber has a greater curvature, thereby making it possible to increase the inner surface area of the reaction chamber. As a result, even if a very high pressure is dominated inside the reaction chamber, the reaction chamber is proof against such a high pressure.

In the above description, the elongated ellipse is referred to. However, it is not restricted to the shape determined by the mathematical definition of an ellipse, i.e., (X²/a²+Y²/b²=1). The term “elongated ellipse” used in the present specification implies a shape having a substantially straight line in the central part (the curvature being substantially 0), including the ellipse, which is determined by the mathematical definition.

The invention described in claim 2 is a circuit component processing apparatus according to claim 1, wherein the reaction means includes outer contact parts which are in contact with the outside of the reaction chamber at the ends.

The invention described in claim 3 is a circuit component processing apparatus according to claim 2, wherein the reaction means is equipped with supercritical water supplying means for supplying the supercritical water into the reaction chamber, passing through a part where the outer contact parts are in contact with the reaction chamber.

The invention described in claim 4 is a circuit component processing apparatus wherein circuit components are reacted with supercritical water, the apparatus including: a reaction means in which the circuit components are reacted with the supercritical water, wherein the reaction means is inclined.

The inclination of the reaction means promotes to convey the gas generated in reaction means upwards above reaction means and to convey solid materials left in reaction means downwards beneath reaction means, thereby making it possible to easily and quickly separate the gas and the solid materials from each other.

The invention described in claim 5 is a circuit component processing apparatus according to claim 4, further including a gas-collecting means for collecting the gas generated in the reaction means from the upper part of the reaction means.

The invention described in claim 6 is a circuit component processing apparatus according to claim 4 or 5, further including residue-collecting means for collecting residual materials in the reaction means, the residue collecting means extending in a direction different from the axial direction of the reaction means.

The invention described in claim 7 is a circuit component processing apparatus according to claim 6, wherein the residue collecting means has a lower bearable limit regarding both the temperature and pressure than the reaction means.

In the residue collecting means, the circumstance is not so severe as that in reaction means, so that the tolerable limits for the temperature and pressure can be reduced, compared with that in reaction means.

The invention described in claim 8 is a circuit component processing apparatus according to claim 6 or 7, further including circuit component storing means for storing the circuit components to be supplied to the reaction means, the circuit component storing means being located under the reaction means and extending in the same direction as that of the reaction means.

Since the axial direction of reaction means is the same as that of the circuit component storing means, the circuit components can be easily and smoothly introduced from the circuit component storing means into the reaction means. Since, however, the axial direction of the solid material collecting means is different from that of reaction means, the collection of the solid materials does not prevent the circuit components from introducing into the reaction means, thereby enabling the circuit components to be quickly introduced into the reaction means.

The invention described in claim 9 is a circuit component processing apparatus according to claim 8, wherein the circuit component storing means has a lower bearable limit regarding both the temperature and pressure than the reaction means.

In the circuit component collecting means, the circumstance is not so severe as that in reaction chamber, so that the tolerable limits for the temperature and pressure can be reduced, compared with that in the reaction chamber.

### BRIEF DESCRIPTION OF THE DRAWINGS

FIG. 1 is a front view of a circuit component processing apparatus 1 in an embodiment of the invention.

FIG. 2 is a longitudinal sectional view of the circuit component processing apparatus 1.

FIG. 3 is a side view of the circuit component processing apparatus 1.

FIG. 4 is a section viewed from line IV-IV in FIG. 1.

FIG. 5 is a partial sectional view of a reaction chamber 14.

FIGS. 6a and 6b are sections viewed from lines VI-VI (VIa-VIa and VIb-VIb) in FIG. 1, respectively.

FIG. 7 is a section viewed from lines VII-VII (VIIa-VIIa) in FIG. 1.

FIGS. 8a and 8b show the procedure of conveying a multi-layer substrate 2 to be processed into the circuit component processing apparatus 1.

FIGS. 9a and 9b show the procedure of processing a multi-layer substrate 2 to be processed with supercritical water.

### BEST MODE FOR CARRYING OUT THE INVENTION

Referring now to the drawings, various embodiments of the present invention will be described.

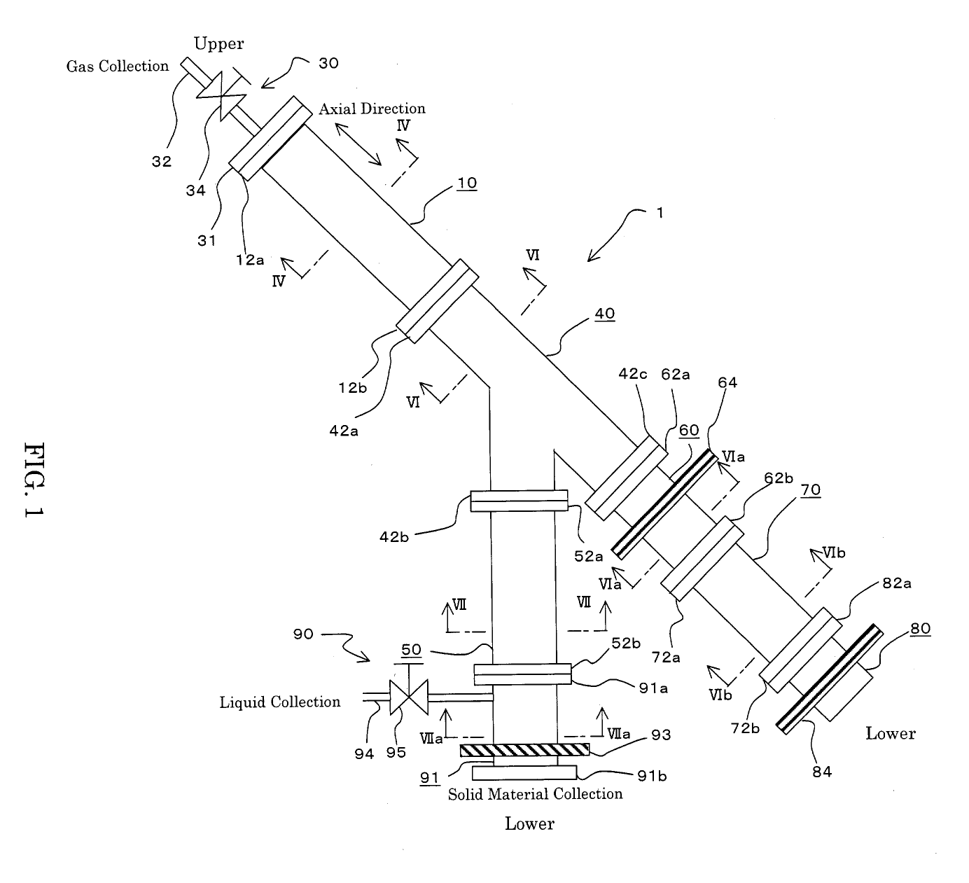

FIG. 1 is a front view of a circuit component processing apparatus 1 in an embodiment of the invention.

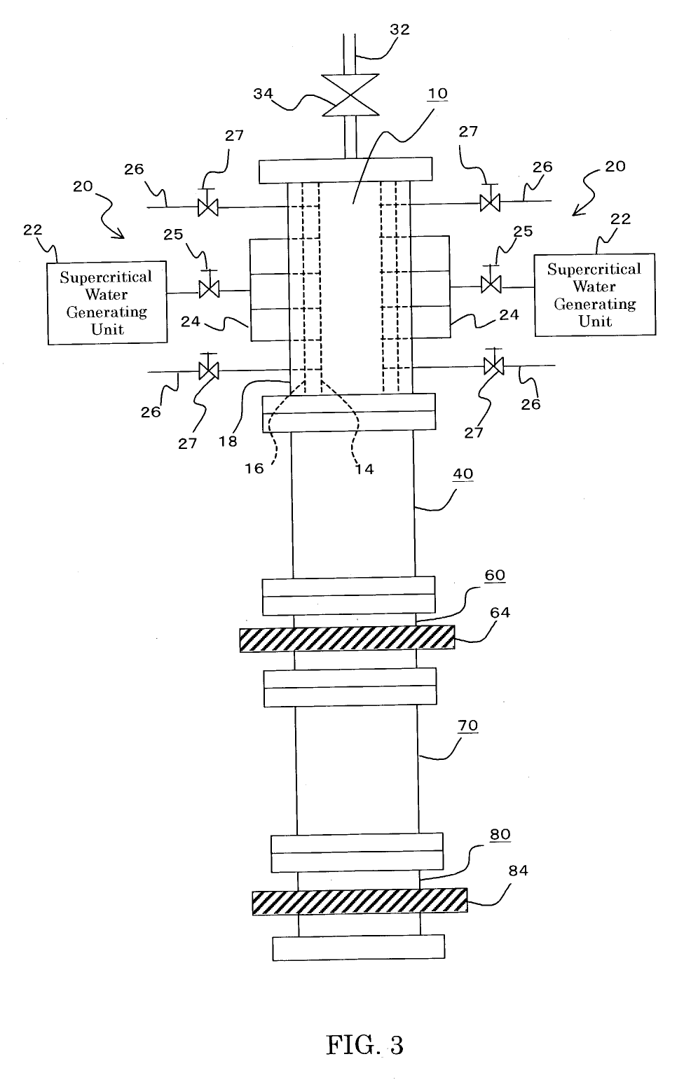

The circuit component processing apparatus 1 is provided with a reaction means 10, a system 20 for supplying supercritical water and air, a gas collecting means 30, a first joint unit 40, a residue collecting means 50, a second joint unit 60, a circuit component storing means 70, a loading unit 80 and a residue classifying unit 90. The system 20 for supplying both supercritical water and air is not shown in FIG. 1, but it is shown in FIG. 3.

The reaction means 10 is inclined at an angle of 45 degrees and located at the upper part of the circuit component processing apparatus 1. In this case, the inclination angle is not restricted to 45 degrees, but it is possible to select it in a range of, for example, 40 to 50 degrees. In the reaction means 10, the circuit components such as multi-layer substrates or the like are reacted with the supercritical water, so that the macro molecular materials in the multi-layer substrates are converted to gas, such as H₂ or CH₄, but metals and inorganic material (glass) remain unchanged. Moreover, water reacted with the multi-layer substrates also remains therein. There are an upper flange 12a and a lower flanges 12b at the upper and lower ends of the reaction means 10, respectively. The system 20 for supplying the supercritical water and air will be later described.

In the gas collecting means 30, a gas, such as H₂ or CH₄, which is generated in the reaction means 10 is collected. The gas collecting means 30 is connected to the upper part of the reaction means 10. The gas collecting means 30 is provided with a flange 31, a stainless pipe 32 and a valve 34. The flange 31 is positioned at the lower end of the gas collecting means 30 and is connected to the flange 12a of the reaction means 10. The stainless pipe 32 is used to pass the gas thus generated therethrough, and the valve 34 serves to connect/disconnect the stainless pipe 32.

There are an upper flange 42a and a lower flange 42b at the upper and lower ends of the first joint unit 40, respectively. The connection of the flange 42a of the first joint unit 40 to the flange 12b of the reaction means 10 provides the connection of the upper end of the first joint unit 40 to the lower end of the reaction means 10. The first joint unit 40 is inclined, and its inclination angle is the same as that of the reaction means 10. In other words, the axial direction of the reaction means 10 is identical with the axial direction of the first joint unit 40. A flange 42c is disposed at the lower end of a part of the first joint unit 40 that is inclined in the same direction as the reaction means 10 (the part extending in the same direction as the axial direction of the reaction means 10). However, the first joint unit 40 is ramified at the center thereof, and a branch (which extends in a direction different from the axial direction of reaction means 10) extends downwards in the vertical direction. The vertical branch is equipped with a flange 42b at its lower end.

There are an upper flange 52a and a lower flange 52b at the upper and lower ends of the residue collecting means 50, respectively. The connection of the flange 52a of the residue collecting means 50 to the flange 42b of the first joint unit 40 provides the connection of the upper end of the residue collecting means 50 to the lower end of the vertical branch of the first joint unit 40. Metals and inorganic materials (glass) in the multi-layer substrates or the like remained in the reaction means 10 as well as the water reacted with the multi-layer substrates or the like falls into the residue collecting means 50 via the first joint unit 40, and then passes through the residue collecting means 50. Thereby, the residues, which remain in the reaction means 10, can be collected by the residue collecting means 50.

There are an upper flange 62a and a lower flange 62b at the upper and lower ends of the second joint unit 60, respectively. The connection of the flange 62a of the second joint unit 60 leads to the connection of the upper end of the second joint unit 60 to the lower end of a part of the first joint unit 40 that extends in the same direction as the axial direction of the reaction means 10. Therefore, the second joint unit 60 is also inclined and its inclination angle is the same as that of the reaction means 10. The second joint unit 60 is equipped with a gate valve 64 at its intermediate part. Closing/opening of the gate valve 64 determines whether the objects to be processed, i.e., the multi-layer substrates or the like, is conveyed from the circuit component storing means 70 to the reaction means 10.

There are an upper flange 72a and a lower flange 72b at the upper and lower ends of the circuit component storing means 70, respectively. The connection of the flange 72a of the circuit component storing means 70 to the flange 62b of the second joint unit 60 leads to the connection of the upper end of the circuit component storing means 70 to the lower end of the second joint unit 60. The objects to be processed, i.e., the multi-layer substrates or the like, are stored in the circuit component storing means 70. The inclination of the circuit component storing means 70 is also similar to that of the reaction means 10.

The loading unit 80 has a flange 82a in its upper end. The connection of the flange 82a of the loading unit 80 to the flange 72b of the circuit component storing means 70 leads to the connection of the upper end of the loading unit 80 to the lower end of the circuit component storing means 70. Moreover, the loading unit 80 has a gate valve 84 in front of the flange 82a. Opening/closing gate valve 84 determines whether the objects to be processed, i.e., the multi-layer substrates or the like, are loaded in circuit component means 70. The inclination of the loading unit 80 is also similar to that of the reaction means 10.

The residue-classifying unit 90 is provided with a pipe 91 for residues, a gate valve 93, a pipe 94 for residouble liquid and a valve 95.

There are an upper flange 91a and a lower flange 91b at the upper and lower ends of the pipe 91 for residues, respectively. The connection of the flange 91a of the pipe 91 for residues to the flange 52b of the residue collecting means 50 provides the connection of the upper end of the pipe 91 for residues to the lower end of the residue collecting means 50. The flange 91b is connected to a tank for collecting residouble solid materials (not shown).

The gate valve 93 is disposed at the intermediate part of the pipe 91 for residouble materials. The pipe 94 for residouble liquid is used to collect water, which flows in the pipe 91 for residouble materials after reacted with the multi-layer substrates or the like. The pipe 94 for residouble liquid is provided with the valve 95.

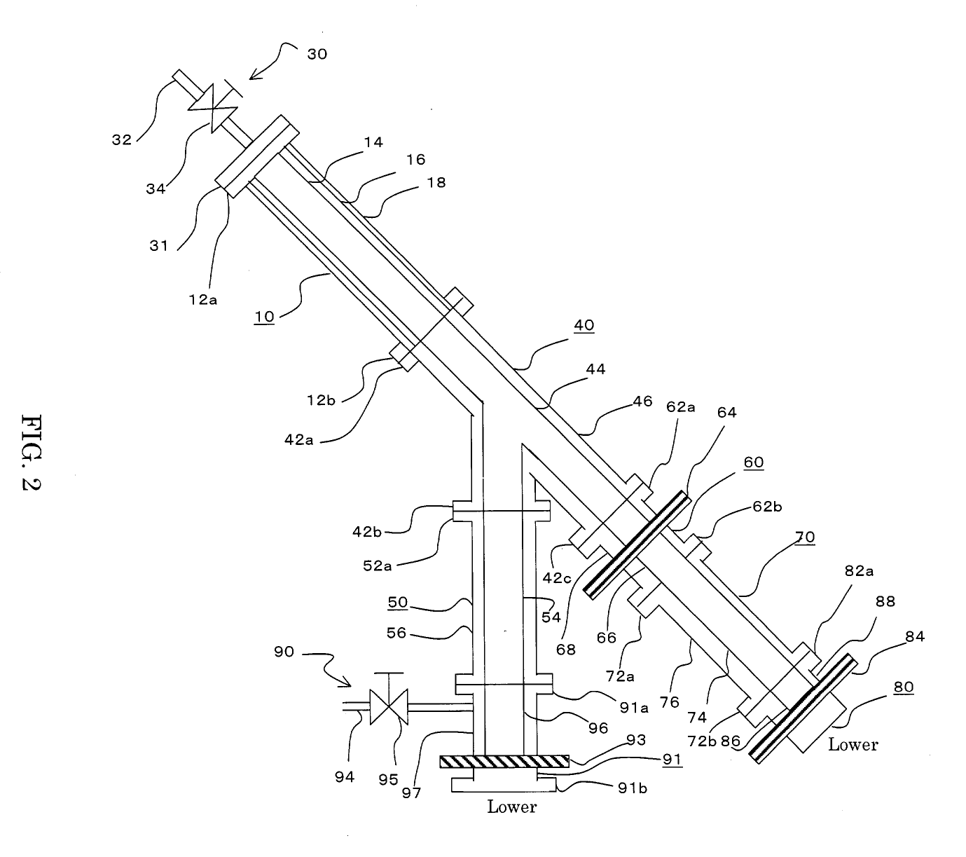

FIG. 2 is a longitudinal sectional view of the circuit component processing apparatus 1. As shown in FIG. 2, the reaction means 10 includes a triple layer structure having a reaction chamber 14, a first outer contact part 16 and a second outer contact part 18. The first joint unit 40 includes a double layer structure having an inner layer 44 and an outer layer 46. The residue collecting means 50 includes a double layer structure having an inner layer 54 and an outer layer 56. The second joint unit 60 includes a double layer structure having an inner layer 66 and an outer layer 68. The circuit component storing means 70 includes a double layer structure having an inner layer 74 and an outer layer 76. The loading unit 80 includes a double layer structure having an inner layer 86 and an outer layer 88. The residue-classifying unit 90 includes a double layer structure having an inner layer 96 and an outer layer 97. Each of the reaction chamber 14, the first outer contact part 16 in contact with the reaction chamber, the second outer contact part 18 in contact with the reaction chamber, the inner layers and the outer layers has a wall thickness. For the purpose of convenience, however, these walls are illustrated without thickness.

Such layer structures having more than two layers are effectively used to operate under severe conditions, i.e., at a high temperature and a high pressure, which result from the reaction of the multi-layer substrates or the like with the supercritical water. In particular, the reaction means 10 having the triple layer structure is operated under the most severe conditions. This is due to the fact that the reaction is carried out exclusively therein. The other components have the double layer structure, since they are positioned apart from the reaction chamber, thereby requiring no tolerance to such severe conditions as in the reaction means 10.

For instance, the reaction chamber 14 in the reaction means 10 has to operate at a temperature of 650° C. and a pressure of 30 MPa, whereas the first joint unit 40 has to operate at a temperature of 400° C. and a pressure of 30 MPa, the residue collecting means 50 has to operate at a temperature of 100° C. and a pressure of 30 MPa and the circuit component storing means 70 has to operate at a temperature of 200° C. and a pressure of 20 Mpa.

FIG. 3 is a side view of the circuit component processing apparatus 1. Referring to FIG. 3, the system 20 for supplying supercritical water and air will be described. The system 20 for supplying supercritical water and air is provided with supercritical water generating units 22, supercritical water supplying pipes 24, valves 25 for supercritical water supply, air supplying pipes 26 and valves 27 for air supply.

The supercritical water-generating unit 22 generates supercritical water at a high temperature and at a high pressure by heating water with a heater. When water is pressed at a temperature of greater than 390° C. up to a pressure of more than 22 MPa (220 Atm.), it becomes supercritical water. The water under such conditions behaves as water clusters having a size of approximately 10 nm, which violently collide with each other, and therefore this state can be regarded as a special state of water, which corresponds neither to liquid phase nor to gas phase. The supercritical water can be assumed to be in a state of a strong acid. It is known that the supercritical water decomposes organic materials, for instance, cellulose such as paper or the like, and converts them to a hydrolyzed product such as glucose, fructose or the like. Furthermore, it is known that organic materials having chemical bonds such as ester bonds, ether bonds, acid amide bonds or the like, which are normally included in a macro molecular material, can be decomposed into simple organic molecules such as monomer, oligomer or the like.

The supercritical water-supplying pipe 24 passes through the reaction means 10, and the one end thereof arrives at the reaction chamber 14. The supercritical water-supplying pipe 24 is a pipe for supplying the supercritical water into the reaction chamber 14. Four supercritical water-supplying pipes 24 are adapted onto each of the left and right sides of the circuit component processing apparatus 1, as shown in FIG. 3. Each valve 25 serves as a valve for controlling the supply of the supercritical water to the reaction chamber 14.

The air-supplying pipe 26 also passes through the reaction means 10 and the one end thereof arrives at the reaction chamber 14. The air-supplying pipe 26 is used as a pipe for supplying air into the reaction chamber 14. Two air-supplying pipes 26 are adapted onto each of the left and right sides of the circuit component processing apparatus 1, as shown in FIG. 3. Each valve 27 serves as a valve for controlling the supply of the air into the reaction chamber 14.

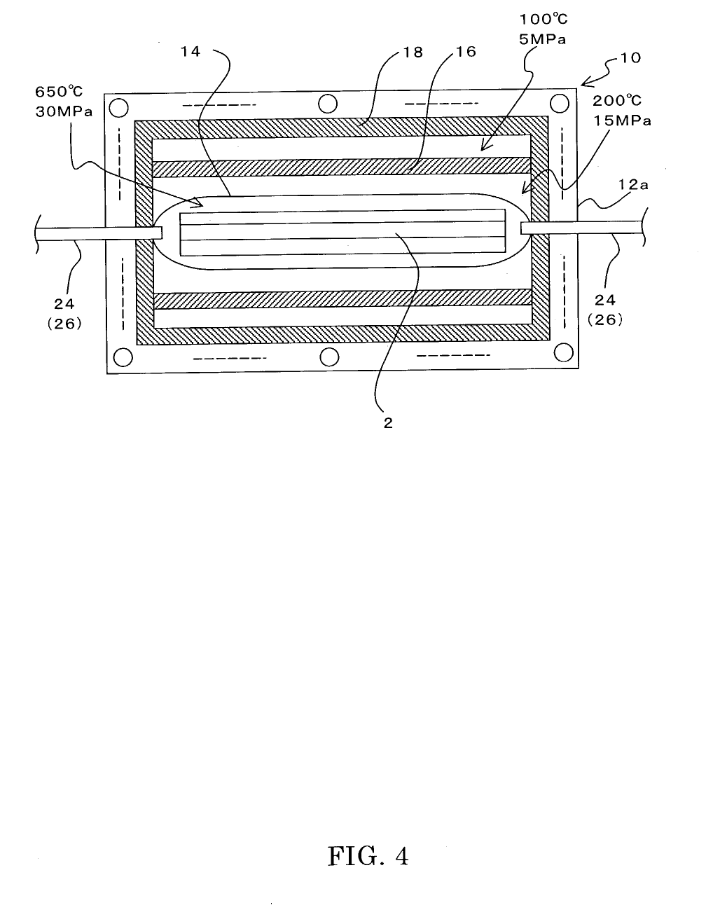

FIG. 4 is a section viewed from line IV-IV in FIG. 1. That is, FIG. 4 shows the cross section of the reaction means 10. The reaction chamber 14 is located at the most inner position inside of the reaction means 10. Multi-layer substrates 2 are accommodated in the reaction chamber 14. The multi-layer substrate 2 is a multi-layer substrate as an object to be processed. The multi-layer substrate 2 includes macro molecular materials, metals and inorganic materials. The macro molecular material is, for example, epoxy or polyimide. The metal is, for example, Au (gold), Ag (silver), Cu (copper), Ni (nickel), Sn (tin) or the like. The inorganic material mentioned here is, for example, glass. These metals are included inside the macro molecular materials. In this embodiment, it is assumed that multi-layer substrates are processed. However, the process apparatus according to the invention can also be applied to the process of IC's (Integrated Circuits) or HIC's (Hybrid Integrated Circuits) onto which IC's are mounted. Hence, the apparatus according to the present invention can generally be used to process these circuit components.

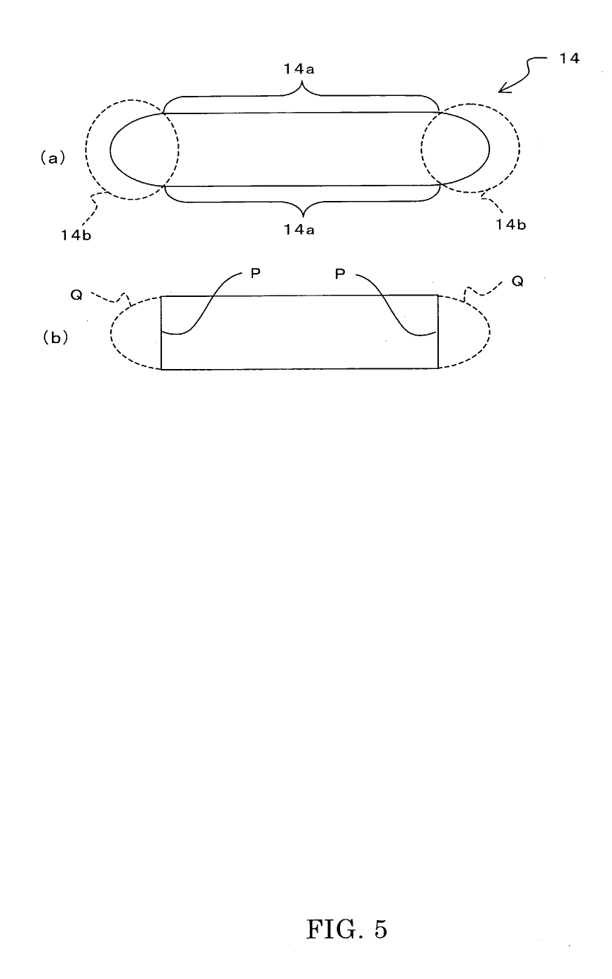

Since the supercritical water is assumed to be in a strong acid state, the reaction chamber 14 is normally produced by a corrosion proof material, such as inconel, stainless steel or the like. The reaction chamber 14 is a hollow elongated ellipsoid having a quasi-straight line with a small curvature at the center part and curved parts with a large curvature at the ends in the longitudinal cross section. The longitudinal section of the reaction chamber 14 will be described in detail, referring to FIGS. 5a and 5b.

As shown in FIG. 5a, the longitudinal section of the reaction chamber 14 exhibits an elongated ellipse which has the center parts 14a, each of which is an approximately straight line with a small curvature, and curved end parts 14b with large curvature. Regarding the shape of the center parts, curved lines can be adopted, but the straight lines (the curvature being 0) can also be selected, as shown in FIGS. 4 and 5a. Since the central parts 14a are substantially straight, flat shaped goods such as multi-layer substrates or the like can easily be inserted into the reaction chamber 14. It is not always necessary that the plane of the central part 14a has to have a greater area than the base surface of the multi-layer substrate or the like.

With regard to an elongated ellipse, it is not always intended to specify the longitudinal cross section of the reaction chamber 14 by the mathematical definition of the ellipse, (X²/a²+Y²/b²=1). The term “elongated ellipse” mentioned herein includes not only an ellipse specified by the above mathematical definition, but also an ellipse represented by the central parts of substantially straight lines (the curvature being 0 at the center part).

Since, moreover, the gas generated by the reaction concentrates in the reaction chamber 14, it is desirable to place goods having a complicated shape therein.

As shown in FIG. 5b, the longitudinal cross section of the reaction chamber 14 is adopted not in the form of a rectangle (P), but in the form of “elongated ellipse” (Q). This is due to the fact that the rectangular cross section provides a greater inner surface area of the reaction chamber 14, thereby allowing withstanding a higher pressure in the reaction chamber 14. Actually, the reaction chamber 14 can be operated, for example, at a high temperature of 650° C. and at a high pressure of 30 MPa.

Returning to FIG. 4, the first outer contact part 16 and the second outer contact part 18 are in contact with the outside of the reaction chamber 14 at the ends thereof. The first outer contact part 16 is made of stainless steel, and the space between the first outer contact part 16 and the reaction chamber 14 is filled with air at a temperature of 200° C. and at a pressure of 15 MPa. The second outer contact part 18 is also made of stainless steel and withstands the air at a temperature of 100° C. and at a pressure of 5 MPa. The space between the second outer contact part 18 and the first outer contact part 16 is filled with N₂. Such a triple layer structure ensures a stable reaction with the supercritical water at a high temperature and high pressure. The insides of the first outer contact part 16 and the second outer contact part 18 are closed by the flange 12b.

The supercritical water supplying pipe 24 and the air supplying pipe 26 pass through the part where the first outer contact part 16 and the second outer contact part 18 are in contact with the outside of the reaction chamber 14 at the ends thereof Such a structural arrangement provides shorter axial lengths of both the supercritical water supplying pipe 24 and the air supplying pipe 26, both passing through the reaction means 10.

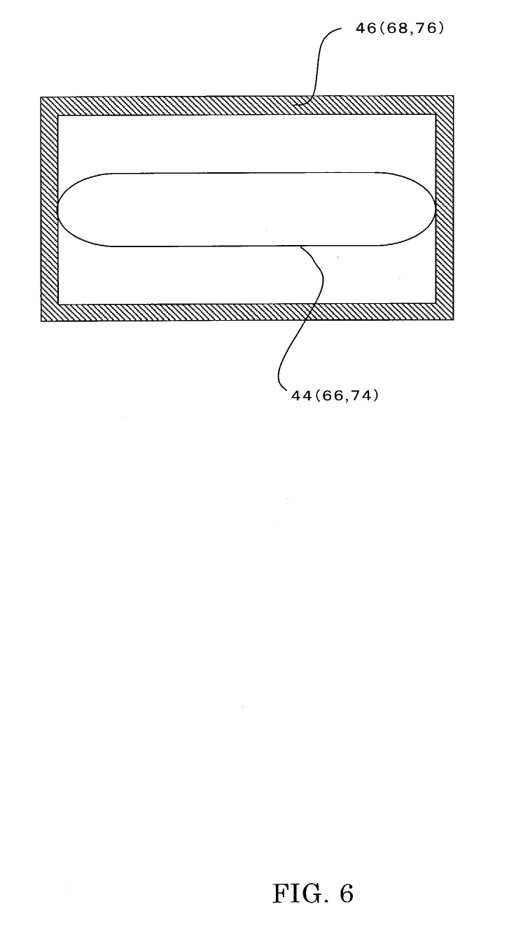

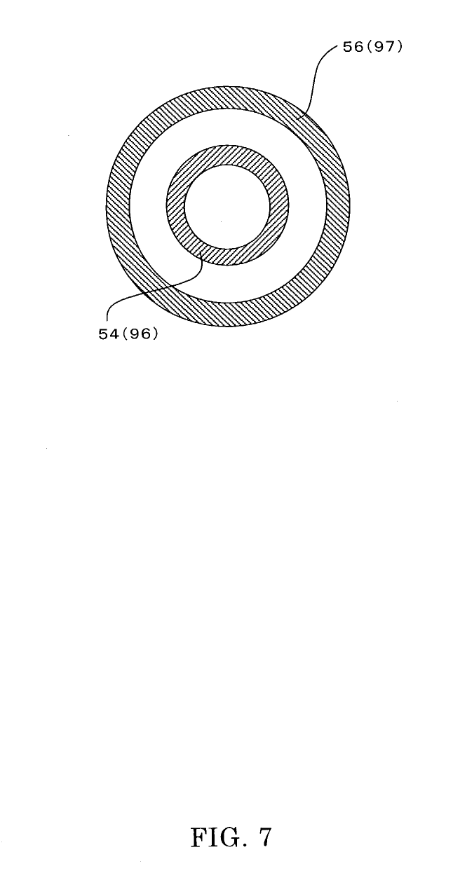

FIG. 6 is a section viewed from line VI-VI (VIa-VIa, VIb-VIb) in FIG. 1. The inner layer 44 (66, 74) has substantially the same shape as the reaction chamber 14, and the outer layer 46 (66, 76) also has substantially the same as the second outer contact part 18. Furthermore, FIG. 7 is a section viewed from line VII-VII (VIIa-VIIa) in FIG. 1. The inner layer 54 (96) and the outer layer 56 (97) have a circular cross section.

In the following, the function of the process apparatus according to the invention will be described.

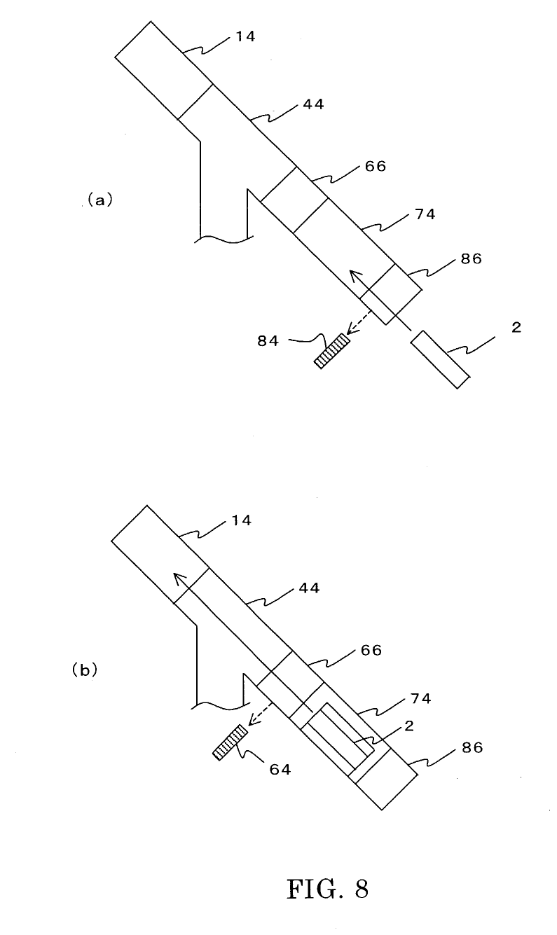

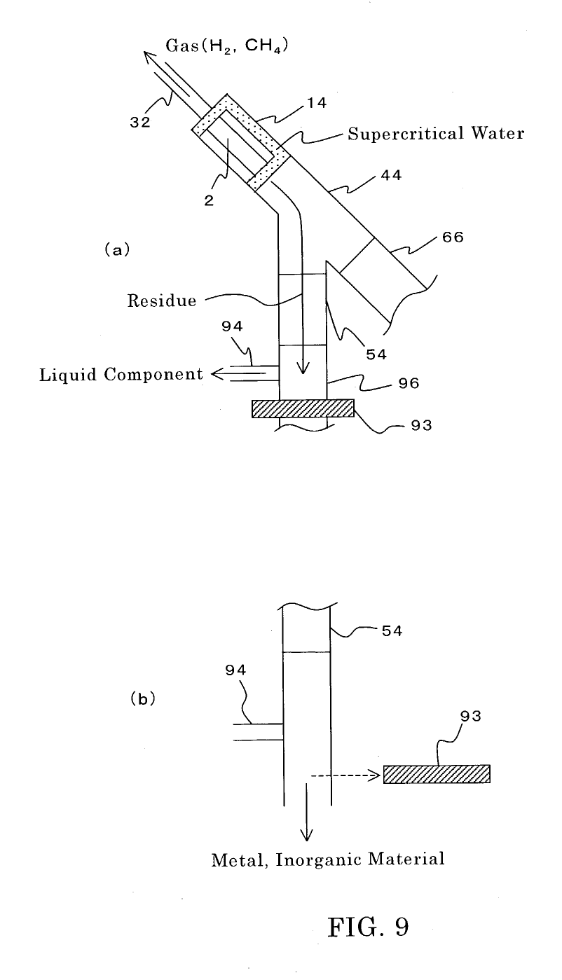

FIG. 8 shows the procedure of loading the multi-layer substrate 2 as an object to be processed in the circuit component processing apparatus 1. FIG. 9 shows the procedure of processing the multi-layer substrate 2 as an object to be processed with the supercritical water. For the sake of simplicity, only main elements, such as multi-layer substrate 2, the reaction chamber 14, the inner layer 44, and the like, are represented.

Firstly, as shown in FIG. 8a, the gate valve 84 is opened, and then the multi-layer substrate 2 is conveyed into the space of the inner layer 74 in the circuit component storing means 70, via the space of the inner layer 86 in the loading unit 80. Secondly, as shown in FIG. 8b, the gate valve 64 is opened, the multi-layer substrate 2 loaded in the circuit component storing means 70 is transferred to the reaction chamber 14. In the transportation of the multi-layer substrate 2 into the reaction chamber 14, a conveying means known in the art, for instance, those using the suction of the multi-layer substrate 2 with a magnet, can be employed.

In this state, the supercritical water is generated by the supercritical water-generating unit 22, and then the valve 25 is opened, so that the supercritical water can be supplied to the reaction chamber 14 via the supercritical water-supplying pipe 24. In conjunction with this, the valve 27 is opened and thus the air containing oxygen can be supplied to the reaction chamber 14 via the air-supplying pipe 26.

After that, the reaction of the multi-layer substrate 2 with the supercritical water and air takes place, as shown in FIG. 9a. The macro molecular materials in the multi-layer substrate 2 are decomposed with the aid of the supercritical water. In this case, metals, such as Cu, Ni, Sn or the like, which are included in the multi-layer substrate, serve as a catalyst in the strong acid of the supercritical water.

In addition, the decomposition of the macro molecular materials in the multi-layer substrate 2 is also performed with the aid of the combustion reaction of oxygen included in the multi-layer substrate 2, the macro molecular materials and the supercritical water. In this case, the introduction of the air containing oxygen into the reaction chamber 14 via the air supplying pipe 26 promotes the combustion reaction, thereby enabling the decomposition of the macro molecular materials in the multi-layer substrate 2 to be accelerated.

Hence, the macro molecular materials can be decomposed into molecules, such as H₂, CH₄ or the like. These gasses are collected in a gas tank (not shown) via a stainless pipe 32.

Moreover, the metals and inorganic materials in the multi-layer substrate 2 as well as the water reacted with the multi-layer substrate 2 remains in the reaction chamber 14. These residues move downwards along the inclined inner surface of the reaction chamber 14, and fall in the branch, which is positioned just beneath the inner layer 44 of the first joint unit 40. Then, by closing the gate valve 93, liquid components of the residues are collected from a pipe 94 for residouble liquid. After completing the collection of the residouble liquid, the gate valve 93 is opened, and then the solid components (metals and inorganic materials) in the residues can also be collected, as shown in FIG. 9b.

Returning the procedure of supplying the multi-layer substrate 2 into the reaction chamber 14 (FIG. 8b), if the number of the multi-layer substrate 2 stored in the circuit component storing means 70 is a few, the multi-layer substrates 2 are loaded in the circuit component storing means 70 (FIG. 8a).

In accordance with the embodiment of the present invention, the central part 14a of the reaction chamber 14 is suitable for conveying a flat material, such as multi-layer substrate 2. Moreover, the curvature of the reaction chamber 14 is large at the ends 14b, and therefore this provides a greater inner surface of the reaction chamber 14. Consequently, the reaction chamber thus designed withstands such a high pressure.

Furthermore, the provision of the first and second outer contact parts 16 and 18 in contact with the reaction chamber makes it possible to design the double layer structure in the vicinity of the reaction chamber 14, thereby enhancing the tolerance against a high pressure inside the reaction chamber 14.

Furthermore, the supercritical water supplying pipes 24 can be designed to pass through the reaction means 10 at the area where the first and second outer contact parts 16 and 18 are in contact with the reaction chamber 14. This provides a smaller distance for the supercritical water supplying pipes 24 passing through the reaction means 10.

In addition, the design of the inclined the reaction means 10 ensures to move the gas generated in the reaction means 10 upwards, and to move the solid materials left in the reaction means 10 downwards, thereby enabling the gas and solid materials to be readily and quickly separated from each other.

In addition, the residue collecting means 50 and the circuit component storing means 70 are operated under less severe conditions than the reaction means and therefore a double layer structure can be employed for both means 50 and 70 which are operated at a lower temperature and at a lower pressure, compared with the reaction means, thereby making it possible to easily manufacture the circuit component processing apparatus 1.

Moreover, the reaction means 10 and the circuit component storing means 70 are aligned in the same axial direction (the same inclination angle). This ensures to smoothly convey the circuit component, such as the multi-layer substrate 2 or the like, from the circuit component storing means 70 to the reaction means 10. It is further noted that the axial direction of both means 10 and 70 is different from that of solid material collecting means 50 and therefore solid materials left in the reaction chamber 14 does not prevent the multi-layer substrate 2 from conveying thereinto. This ensures the quick and continual supply of the multi-layer substrate 2.

The circuit component processing apparatus 1 in accordance with the embodiment of the present invention is constituted by separable parts, which can be jointed by corresponding flanges. This structure provides an advantage in the process of manufacturing.

In accordance with the present invention, the reaction chamber has a flat shape at its central part and therefore is suitable for conveying the circuit components thereinto. In conjunction with this structural feature, the reaction chamber has a greater curvature at each end and thus provides a greater inner surface of the reaction chamber, hence enabling the reaction chamber to be proof against a high pressure.

1. A circuit component processing apparatus wherein circuit components are reacted with supercritical water, said apparatus comprising:
a reaction means in which said circuit components are reacted with said supercritical water,
wherein said reaction means is equipped with an elongated ellipse cylinder shaped reaction chamber having a hollow ellipse cross section, said reaction chamber having a small curvature at the center part, thereby exhibiting substantially straight line, and a large curvature at its ends.

2. A circuit component processing apparatus according to claim 1, wherein said reaction means includes outer contact parts which are in contact with the outside of said reaction chamber at said ends.

3. A circuit component processing apparatus according to claim 2, wherein said reaction means is equipped with supercritical water supplying means for supplying the supercritical water into said reaction chamber, passing through a part where said outer contact parts are in contact with said reaction chamber.

4. A circuit component processing apparatus wherein circuit components are reacted with supercritical water, said apparatus comprising:
a reaction means in which said circuit components are reacted with said supercritical water,
wherein said reaction means is inclined.

5. A circuit component processing apparatus according to claim 4, further comprising a gas-collecting means for collecting the gas generated in said reaction means from the upper part of said reaction means.

6. A circuit component processing apparatus according to claim 4 or 5, further comprising residue-collecting means for collecting residual materials in said reaction means, said residue collecting means extending in a direction different from the axial direction of said reaction means.

7. A circuit component processing apparatus according to claim 6, wherein said residue collecting means has a lower bearable limit regarding both the temperature and pressure than said reaction means.

8. A circuit component processing apparatus according to claim 6 or 7, further comprising circuit component storing means for storing said circuit components to be supplied to said reaction means, said circuit component storing means being located under said reaction means and extending in the same direction as that of said reaction means.

9. A circuit component processing apparatus according to claim 8, wherein said circuit component storing means has a lower bearable limit regarding both the temperature and pressure than said reaction means.
